(19) United States
(12) Patent Application Publication
(10) Pub. No.: US 2026/0274323 A1
(43) Pub. Date: Sep. 17, 2026

(54) STEERING DEVICE

(71) Applicant: HONDA MOTOR CO., LTD., Tokyo (JP)

(72) Inventor: Takeshi OBA, Minato-ku (JP)

(21) Appl. No.: 19/554,220

(22) Filed: Mar. 2, 2026

(30) Foreign Application Priority Data
Mar. 17, 2025 (JP) 2025-042272

(51) Int. Cl. B62D 1/04; B60K 26/02; B60T 7/10

(52) U.S. Cl. CPC B62D 1/04; B60K 26/02; B60T 7/10

(57) ABSTRACT

A steering device includes: a mounting base member installed on a vehicle body; a pair of grip base members arranged laterally on opposite sides of the mounting base member at equal distances; an upper steering member connecting the mounting base member and the grip base member; a lower steering member connecting the mounting base member and the grip base member; a steering wheel linking the mounting base member and the grip base members so as to rotate a steering output shaft during steering with a mounting line, composed of a straight line connecting upper and lower mounting link points, and a base line, composed of a straight line connecting upper and lower base link points, remaining parallel to each other; and a control means arranged on each of the grip base members and configured to accelerate and decelerate a vehicle.

### CROSS-REFERENCE TO RELATED APPLICATION

This application claims the benefit of priority under 35 U.S.C. § 119 to Japanese Patent Application No. 2025-042272 filed on Mar. 7, 2025, the entire contents of which are incorporated herein by reference.

### TECHNICAL FIELD

The present invention relates to a steering device for steering a vehicle or the like.

### BACKGROUND OF THE INVENTION

There has been a disclosed configuration in which a driver controls an acceleration and deceleration control device, installed on a steering device, by hand when accelerating or decelerating a vehicle, instead of controlling a foot pedal. For example, the steering device disclosed in Japanese Patent Application No. 2022-116565 (published as 2024-014028A: hereinbelow, referred to as Patent Document 1) includes an acceleration and deceleration control device installed in vicinity to the right and left grips of the steering wheel and set to be used for acceleration and deceleration control while steering.

### SUMMARY OF THE INVENTION

### Problems to Be Solved

Incidentally, the gripping positions cannot be changed freely with the configuration where an acceleration and deceleration control device is installed on a steering wheel as described above, so that there is a possibility of having strain on the wrist, elbow, and/or shoulder, and/or interference with acceleration and deceleration control operation, during hard steering.

The present invention has been devised in view of the above-described problems and is intended to provide a steering device capable of reducing strain on the wrist, elbow, and/or shoulder as well as preventing interference with acceleration and deceleration control operation, even during hard steering.

### Solution to Problem

In order to achieve the above-described objective, a steering device according to the present invention comprises: a mounting base member installed on a vehicle body; a pair of grip base members arranged laterally on opposite sides of the mounting base member at equal distances; an upper steering member connecting an upper mounting link point of the mounting base member and an upper base link point of the grip base member, via a rotation shaft along a front-rear or vertical direction; a lower steering member connecting a lower mounting link point of the mounting base member and a lower base link point of the grip base member, via a rotation shaft along the front-rear or vertical direction; a link mechanism linking the mounting base member and the grip base members so as to rotate a steering output shaft during steering with a mounting line, composed of a straight line connecting the upper and lower mounting link points, and a base line, composed of a straight line connecting the upper and lower base link points, remaining parallel to each other; and a control means arranged on each of the grip base members and configured to accelerate and decelerate a vehicle.

### Advantageous Effects of the Invention

The present invention provides a steering device capable of reducing strain on the wrist, elbow, and/or shoulder as well as preventing interference with acceleration and deceleration control operation, even during hard steering.

### BRIEF DESCRIPTION OF DRAWINGS

FIG. 1 is a front view of a steering device according to a first embodiment when a vehicle is traveling straight;

FIG. 2 is a side view of the steering device according to the first embodiment when the vehicle is traveling straight;

FIG. 3 is a front view of the steering device according to the first embodiment at the maximum steering angle to the right;

FIG. 4 is a cross-sectional view taken along a line B-B in FIG. 2;

FIG. 5 is a cross-sectional view taken along a line A-A in FIG. 1;

FIG. 6 is a cross-sectional view taken along a line C-C in FIG. 2;

FIG. 7 is a front view of a steering device according to a second embodiment when the vehicle is traveling straight;

FIG. 8 is a side view of the steering device according to the second embodiment when the vehicle is traveling straight;

FIG. 9 is a front view of the steering device according to the second embodiment at the maximum steering angle to the right;

FIG. 10 is a cross-sectional view taken along a line F-F in FIG. 8;

FIG. 11 is a cross-sectional view taken along a line E-E in FIG. 7;

FIG. 12 is a cross-sectional view taken along a line G-G in FIG. 8;

FIG. 13 is a cross-sectional view taken along a line D-D in FIG. 7;

FIG. 14 is a front view of a steering device according to a third embodiment when the vehicle is traveling straight;

FIG. 15 is a front view of the steering device according to the third embodiment at the maximum steering angle to the right;

FIG. 16 is a frontal transparent view of the steering device according to the third embodiment when the vehicle is traveling straight;

FIG. 17 is a side view of the steering device according to the third embodiment when the vehicle is traveling straight;

FIG. 18 is a front view of a steering device according to a fourth embodiment when the vehicle is traveling straight;

FIG. 19 is a side view of the steering device according to the fourth embodiment when the vehicle is traveling straight;

FIG. 20 is a front view of the steering device according to the fourth embodiment at the maximum steering angle to the right;

FIG. 21 is a cross-sectional view taken along a line J-J in FIG. 19;

FIG. 22 is a cross-sectional view taken along a line H-H in FIG. 19; and

FIG. 23 is a cross-sectional view taken along a line I-I in FIG. 19.

### DETAILS DESCRIPTION

### First Embodiment

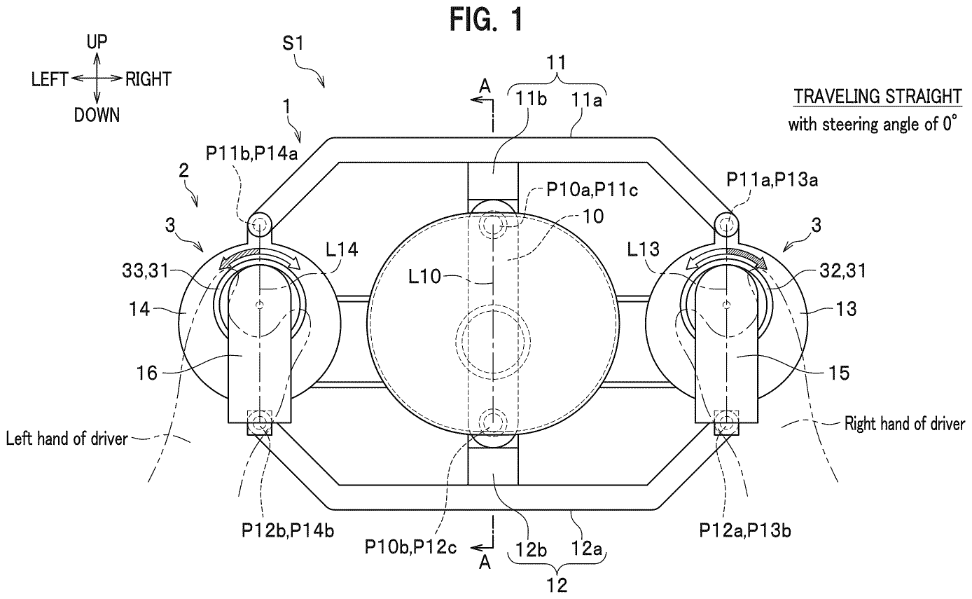

A description is given in detail of a steering device S1 of a first embodiment according to the present invention, with reference to FIGS. 1 to 6. Note that identical components are denoted by the same reference signs and duplicate descriptions thereof are skipped in the description.

The steering device S1 of the embodiment is configured to allow a driver to steer, and accelerate and decelerate a vehicle by hand. The vehicle (not shown) having the steering device S1 is configured with a so-called “by-wire” system to transmit the amount of steering, accelerator, and braking operation via wire harnesses (not shown). The steering device S1 includes a steering wheel 1 (link mechanism) and an acceleration and deceleration structure 2.

The steering wheel 1 (link mechanism) is configured to convert steering operation by the driver into an electrical signal and output it to the outside. The steering wheel 1 includes a mounting base member 10, an upper steering member 11, a lower steering member 12, a right grip base member 13, a left grip base member 14, a right grip body 15, a left grip body 16, and a steering output unit (not shown).

The mounting base member 10 is a component installed on a vehicle body via a steering column (not shown). The mounting base member 10 is composed of a substantially rectangular, plate-shaped metal member. The mounting base member 10 is arranged such that the rectangular shape lengthwise aligns with the vertical direction, and the plate surface faces a front-rear direction. The mounting base member 10 is provided with an upper mounting link point P10a at its upper end and a lower mounting link point P10b at its lower end.

The upper steering member 11 is composed of a substantially T-shaped metal plate, including an upper lateral piece 11a extending in a lateral direction and an upper vertical piece 11b extending in the vertical direction. The upper steering member 11 is provided with an upper right steering link point P11a at the right end of the upper lateral piece 11a, an upper left steering link point P11b at the left end of the upper lateral piece 11a, and an upper central steering link point P11c at the lower end of the upper vertical piece 11b. The lower steering member 12 is composed of a substantially inverted T-shaped metal plate, including a lower lateral piece 12a extending in the lateral direction and a lower vertical piece 12b extending in the vertical direction. The lower steering member 12 is provided with a lower right steering link point P12a at the right end of the lower lateral piece 12a, a lower left steering link point P12b at the left end of the lower lateral piece 12a, and a lower central steering link point P12c at the upper end of the lower vertical piece 12b.

The right grip base member 13 is provided with an upper right base link point P13a (upper base link point) at its upper end and a lower right base link point P13b (lower base link point) at its lower end. The left grip base member 14 is provided with an upper left base link point P14a (upper base link point) at its upper end and a lower left base link point P14b (lower base link point) at its lower end. Note that the dimensions between the upper and lower mounting link points P10a and P10b of the mounting base member 10, between the upper and lower right base link points P13a and P13b of the right grip base member 13, and between the upper and lower left base link points P14a and P14b of the left grip base member 14 are all set to be equal. Likewise, the dimensions between the right and central upper steering link points P11a and P11c, between the left and central upper steering link point P11b and P11c, between the right and central lower steering link points P12a and P12c, and the left and central lower steering link points P12b and P12c are all set to be equal.

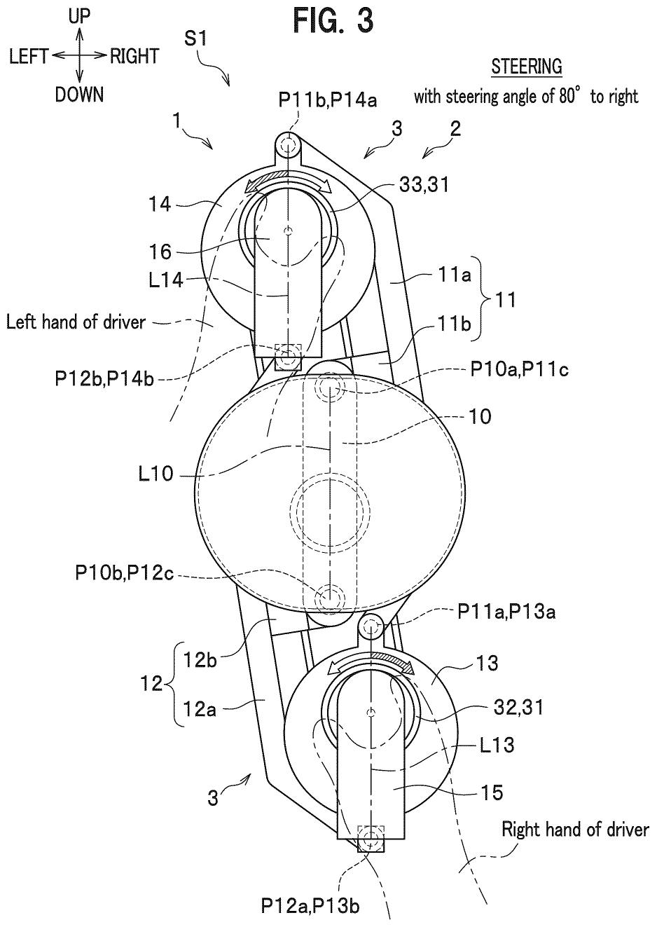

Then, the upper mounting link point P10a and central upper steering link point P11c are rotatably supported by a rotation shaft extending in the front-rear direction, and the lower mounting link point P10b and central lower steering link point P12c are rotatably supported by a rotation shaft extending in the front-rear direction (see FIGS. 1 and 3). Likewise, the right upper steering link point P11a and upper right base link point P13a are rotatably supported by a rotation shaft extending in the front-rear direction, and the left upper steering link point P11b and upper left base link point P14a are rotatably supported by a rotation shaft extending in the front-rear direction. Further, the right lower steering link point P12a and lower right base link point P13b are rotatably supported by a rotation shaft extending in the front-rear direction, and the left lower steering link point P12b and lower left base link point P14b are rotatably supported by a rotation shaft extending in the front-rear direction.

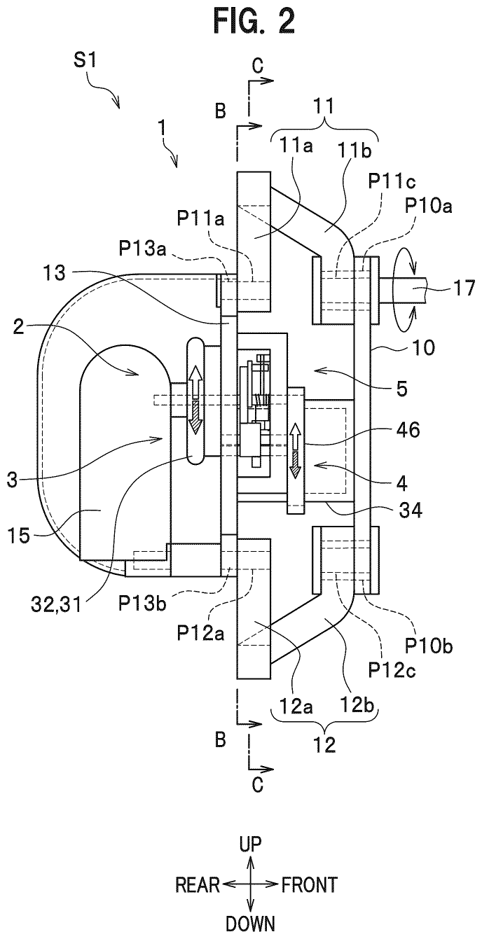

Note that the rotation shaft connecting the upper mounting link point P10a and central upper steering link point P11c is configured as a steering output shaft 17 (see FIG. 2) in the embodiment. With this configuration, a mounting line L10 and a right base line L13 (base line) and a left base line L14 (base line) are rotated about the steering output shaft 17 during steering, while remaining parallel. Here, the mounting line L10 is a straight line connecting the upper mounting link point P10a and lower mounting link point P10b. Likewise, the right base line L13 (base line) is a straight line connecting the upper right base link point P13a and lower right base link point P13b. The left base line L14 (base line) is a straight line connecting the upper left base link point P14a and lower left base link point P14b.

When the vehicle is traveling straight, the upper and lower steering members 11 and 12 are kept horizontal, and the right and left grip base members 13 and 14 are held at the same height as the mounting base member 10 (mode of traveling straight), as shown in FIG. 1. When the vehicle is steered to the right from the mode of traveling straight (steering to the right), the left grip base member 14 is moved rightward, while being moved upward relative to the mounting base member 10, and the right grip base member 13 is moved leftward, while being moved downward relative to the mounting base member 10 (mode of steering to the right), as shown in FIG. 3. When the vehicle is steered to the right, the steering output shaft 17 rotates clockwise. Likewise, when the vehicle is steered to the left from the mode of traveling straight (steering to the left), the left grip base member 14 is moved rightward, while being moved downward relative to the mounting base member 10, and the right grip base member 13 is moved leftward, while being moved upward relative to the mounting base member 10 (mode of steering to the left: not shown). When the vehicle is steered to the left, the steering output shaft 17 rotates counterclockwise.

The right grip body 15 is a part gripped by the right hand of the driver when the driver controls the steering device S1 (see FIGS. 1 to 3). The right grip body 15 is composed of a rod-shaped member set to dimensions suitable for the driver to grip. The right grip body 15 extends vertically, with its lower end supported by and fixed to the right grip base member 13.

Likewise, the left grip body 16 is a part gripped by the left hand of the driver when the driver controls the steering device S1. The left grip body 16 is composed of a rod-shaped member set to dimensions suitable for the driver to grip. The left grip body 16 extends vertically, with its lower end supported by and fixed to the left grip base member 14.

The steering output unit (not shown) outputs a steering angle by the driver as an electrical signal and is provided on the steering output shaft 17. For example, a variable resistor such as a potentiometer may be used as the steering output unit. The steering output unit is mounted on the steering output shaft 17 and outputs the rotated angle of the steering output shaft 17 as a steering angle in the form of an electrical signal. The steering output shaft 17 is also mechanically connected to a mechanism (not shown) to generate steering reaction force, which is transmitted to the driver via the right and left grip bodies 15 and 16.

The acceleration and deceleration structure 2 is configured to convert acceleration and deceleration control operation by the driver into electrical signals and output them to the outside (see FIGS. 1 to 3). The acceleration control operation on the acceleration and deceleration structure 2 corresponds to accelerator operation on a typical vehicle, while the deceleration control operation corresponds to braking operation on a typical vehicle. The acceleration and deceleration structure 2 includes a control means 3, a lateral interlocking means 4, and a reaction force generating means 5. The control means 3 is a part controlled by the driver when the vehicle. is accelerated or decelerated. The control means 3 includes a pair of control units 31 (right control unit 32 and left control unit 33) and an acceleration and deceleration output unit 34.

The driver uses the right control unit 32 for acceleration and deceleration control with fingertips, while gripping the right grip body 15 with the right hand. The right control unit 32 has a disk-like dial shape, and is rotatably supported at the center of the disk by a portion of the right grip base member 13, which supports an upper end of the right grip body 15, with the surface of the disk facing the front-rear direction. In other words, the rotation axis of the right control unit 32 is set to extend in the front-rear direction. The right control unit 32 is configured to accelerate the vehicle when rotated clockwise and decelerate the vehicle when rotated counterclockwise. A neutral position is set between the acceleration and deceleration positions. The vehicle is neither accelerated nor decelerated at the neutral position, and thus the vehicle remains stationary when stationary, and coasts by inertia when traveling.

The driver uses the left control unit 33 for acceleration and deceleration control with fingertips, while gripping the left grip body 16 with the left hand. The left control unit 33 has the same dial shape as the right control unit 32, and is rotatably supported at the center of the disk by a portion of the left grip base member 14, which supports an upper end of the left grip body 16, with the surface of the disk facing the front-rear direction. In other words, the rotation axis of the left control unit 33 is set to extend in the front-rear direction. The left control unit 33 is configured to accelerate the vehicle when rotated counterclockwise and decelerate the vehicle when rotated clockwise.

Accordingly, the right and left control units 32 and 33 are configured to accelerate the vehicle when moved outward from the center of the steering device S1, and decelerate the vehicle when moved inward toward the center of the steering device S1.

Note that the right and left control units 32 and 33 can also be configured, as a modification of the embodiment, to accelerate the vehicle when moved inward toward the center of the steering device S1, and decelerate the vehicle when moved outward from the center of the steering device S1, contrary to the embodiment. Alternatively, both the right and left control units 32 and 33 can be configured, as another modification, to accelerate the vehicle when rotated clockwise, and decelerate the vehicle when rotated counterclockwise. That is, the directions for acceleration and deceleration control operation are not limited to those described in the embodiment and can be suitably set or changed based on the driver preferences.

Acceleration and deceleration control operation by the driver is outputted as an electrical signal from the rotation angle of the right control unit 32, using a variable resistor (not shown), such as a potentiometer, arranged in the right grip base member 13 or right grip body 15. Likewise, the rotation angle of the left control unit 33 may be outputted. For anomaly detection, the rotation angles of both the right and left control units 32 and 33 may be outputted.

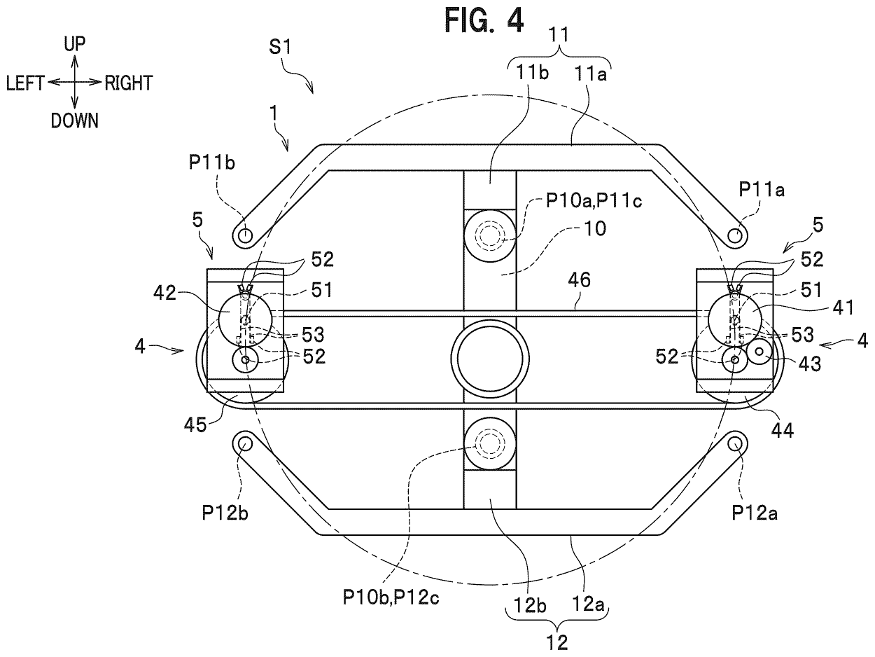

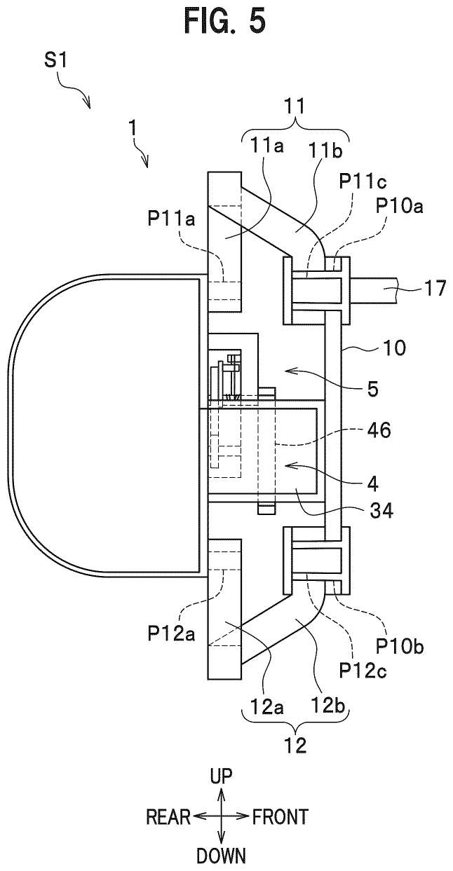

The lateral interlocking means 4 is configured to transmit the motion of one to the other to interlock them, when the driver controls either one of the control units 31, that is, the right control unit 32 or left control unit 33 (see FIGS. 4 and 5). Interlocking the right and left control units 31 prevents them from being controlled independently. This helps prevent a driver error. The lateral interlocking means 4 includes a right operating gear 41, a left operating gear 42, a reversing gear 43, a right pulley 44, a left pulley 45, and a toothed belt 46.

The right operating gear 41 is a spur gear formed integrally, and rotates together, with the disk of the right control unit 32. The left operating gear 42 is a spur gear formed integrally, and rotates together, with the disk of the left control unit 33. The left operating gear 42 is formed in the same shape as the right operating gear 41. The reversing gear 43 is a spur gear to mesh with the right operating gear 41 and is rotatably supported by the right grip base member 13.

The right pulley 44 is a toothed pulley having a spur gear to mesh with the right operating gear 41 and having the toothed belt 46 wound therearound, and is rotatably supported by the right grip base member 13. The left pulley 45 is a toothed pulley having a spur gear to mesh with the left operating gear 42 and having the toothed belt 46 wound therearound, and is rotatably supported by the left gripping base 14. The left pulley 45 is formed in the same shape as the right pulley 44. The toothed belt 46 is wound around both the right pulley 44 and left pulley 45 to transmit rotation of the right pulley 44 to the left pulley 45 and vice versa.

In other words, the right operating gear 41, left operating gear 42, reversing gear 43, right pulley 44, and left pulley 45 are rotatably supported by rotation shafts extending in the front-rear direction. As the reversing gear 43 meshes between the right operating gear 41 and right pulley 44, the left control unit 33 is also moved outward from the center of the steering device S1 when the driver moves the right control unit 32 outward from the center of the steering device S1 (acceleration control operation). Note that the lateral interlocking means 4 of the embodiment uses a belt-type parallel link mechanism with the toothed belt 46, but the present invention is not limited to this configuration. For example, operation on one control means 3 may be transmitted to the other via a gear mechanism (not shown) composed of gears and shafts, to achieve the same advantageous effects as the embodiment.

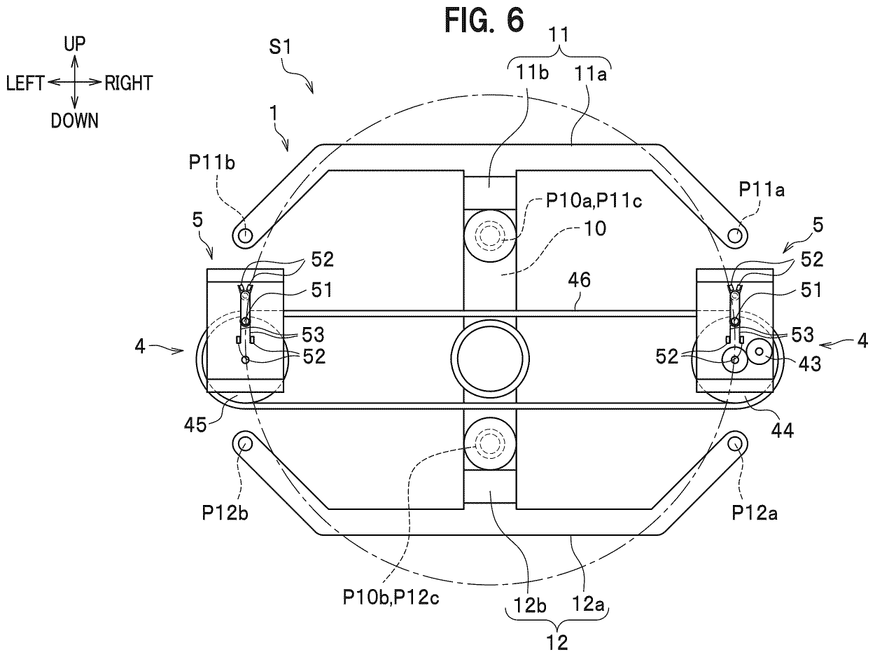

The reaction force generating means 5 are configured to bias each of the right and left control units 31 toward the neutral position either from the acceleration or deceleration position (see FIG. 6). The reaction force generating means 5 is provided on each of the right and left grip base members 13 and 14. When the driver releases the fingers from the right or left control unit 31, the reaction force generating means 5 automatically returns the unit from the acceleration or deceleration position to the neutral position. In other words, the reaction force generating means 5 biases the control unit 31 toward a direction opposite to the moving direction, when the driver controls or moves the control unit 31 of the control means 3. The reaction force generating means 5 is composed of a reaction force lever 51, locking protrusions 52, and a return spring 53.

The reaction force lever 51 is fixed to each of the right and left operating gears 41 and 42, and rotates coaxially with it. The reaction force lever 51 has a cylindrical protrusion extending frontward at the opposite end thereof to an end thereof penetrated by the coaxial shaft. The locking protrusions 52 are provided on each of the right and left grip base members 13 and 14. The return spring 53 consists of two torsion springs with flexibility. The return spring 53 is set on each of the right and left control units such that a shaft of the right operating gear 41 or left operating gear 42 extends through a coil portion of the spring. The return spring 53 has straight portions at both ends thereof being in contact with and locked to the locking protrusions 52 on each of the right and left grip base members 13 and 14 and clamps the cylindrical protrusion of the reaction force lever 51 on opposite sides. Acceleration control operation by the driver causes one torsion spring of the return spring 53 to deflect and its restoring force pushes each of the right and left operating gears 41 and 42 from the acceleration position back to the neutral position via the cylindrical protrusion of the reaction force lever 51. Likewise, deceleration control operation by the driver causes the other torsion spring of the return spring 53 to deflect and its restoring force pushes each of the right and left operating gears 41 and 42 from the deceleration position back to the neutral position via the cylindrical protrusion of the reaction force lever 51.

Note that the reaction force generating means 5 of the embodiment uses torsion springs to generate a reaction force, but the present invention is not limited to this form. For example, the reaction force generating means 5 may generate a reaction force using an actuator or a motor.

Next, a description is given of advantageous effects of the embodiment. The steering device S1 of the embodiment has the steering handle 1 (link mechanism) linking the mounting base member 10 and the right and left grip base members 13 and 14 so as to rotate the steering output shaft 17 during steering with the mounting line L10 and the right and left base lines L13 and L14 (base lines) remaining parallel to each other. Additionally, the control means 3 are provided on each of the right and left grip base members 13 and 14. Such a configuration is capable of reducing discomfort on gripping and strain on the wrist, elbow, and/or shoulder for the driver when steering without switching the grip between the right and left grip bodies 15 and 16 as well as preventing interference between the steering operation and the acceleration and deceleration control operation. The driver can also firmly grip the steering wheel 1 and steer precisely, even during acceleration and deceleration control operation, to allow for keeping stable trunk posture as well as steering precisely.

In addition, the embodiment includes the lateral interlocking means 4 arranged on the right and left grip bodies 15 and 16 (grip bodies), respectively, and configured to transmit operation on one of the control means 3 to the other to interlock them. Such a configuration allows efficient interlocking on acceleration and deceleration control operation, even when the right and left control units for acceleration and deceleration are displaced significantly and parallel due to steering. Interlocking the right and left control units for acceleration and deceleration also integrates acceleration and deceleration control operation by the driver on the right and left sides, to prevent a driver error.

Further, the embodiment has the right and left control units 31 having a disk-like dial shape and rotatably supported at the center of the disk. Such a configuration allows the driver to pinch and control the dial using the thumb and opposing fingers, to allow precise control and quick switching between acceleration and deceleration, even with one hand. Additionally, as various fingers can be used, the device can flexibly accommodate situations where the fingertips are weakened or certain fingers are impaired.

Still further, the embodiment has the right and left grip bodies 15 and 16 (grip bodies) fixed to the right and left grip base members 13 and 14 (grip base members), respectively, in a vertically aligned orientation. The control means 3 are positioned so as to be controlled by the driver with the fingertips of gripping hands, while the driver gripping the right and left grip bodies 15 and 16. Such a configuration enhances posture stability when the driver gripping the right and left grip bodies 15 and 16, to allow for more precise acceleration and deceleration control. Note that the embodiment has the steering wheel 1 arranged to face the front-rear direction, so that the rotation shafts of the link points and the steering output shaft 17 are aligned along the front-rear direction, but the present invention is not limited to this mode. For example, the rotation shafts of the link points and the steering output shaft may be arranged along the vertical direction, as with steering wheel of a truck.

### Second Embodiment

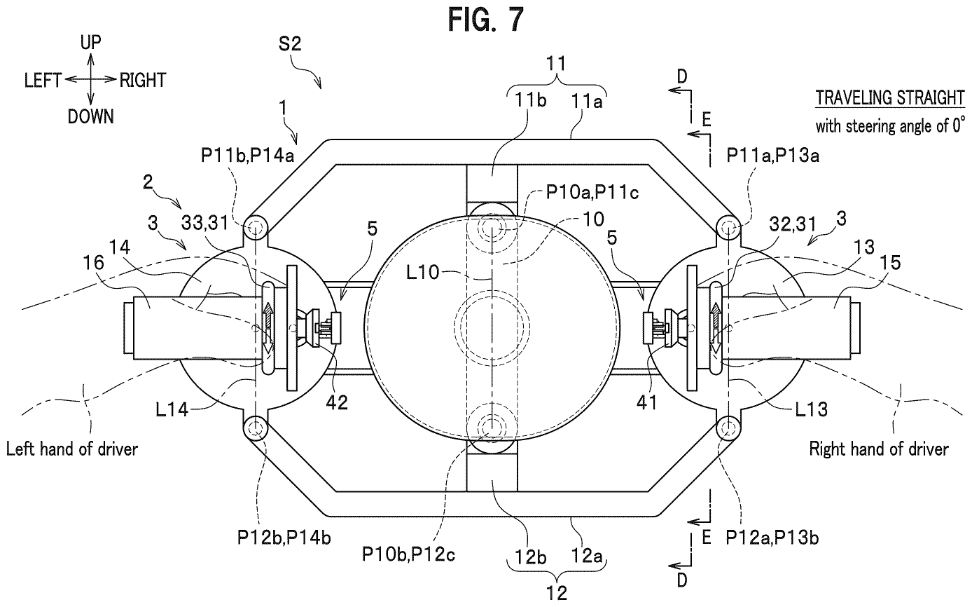

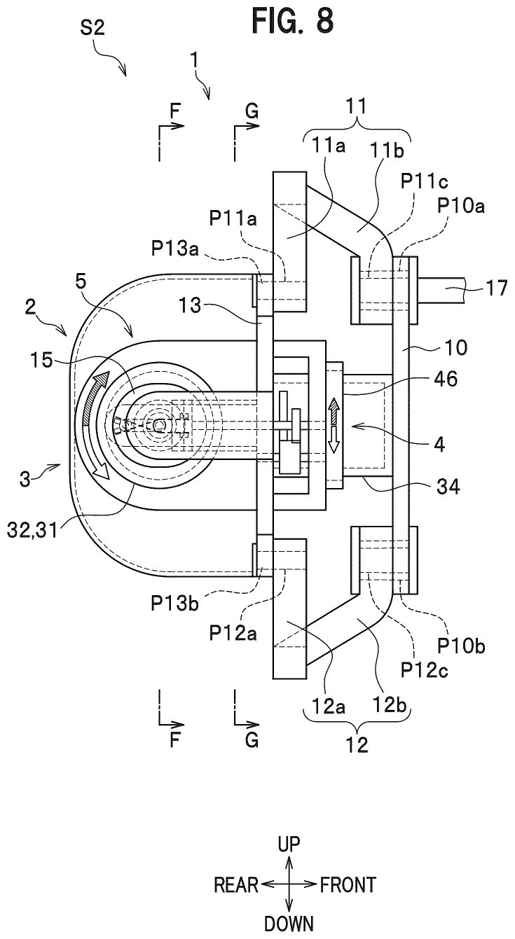

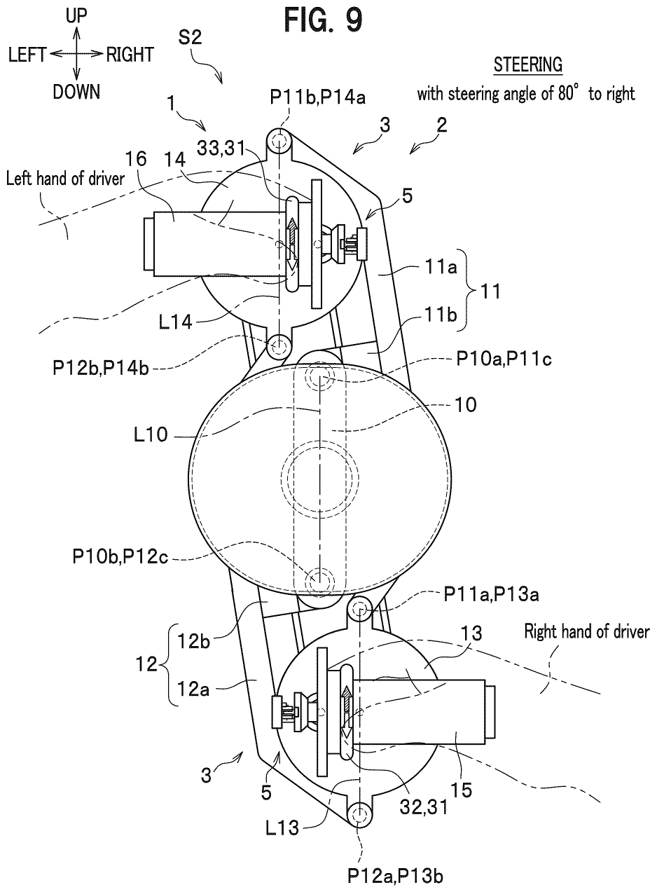

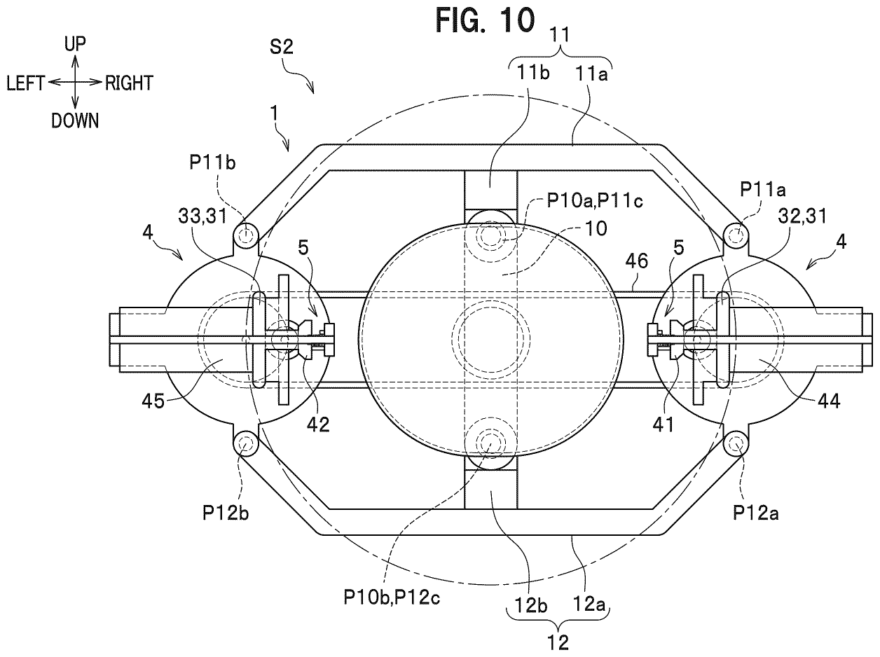

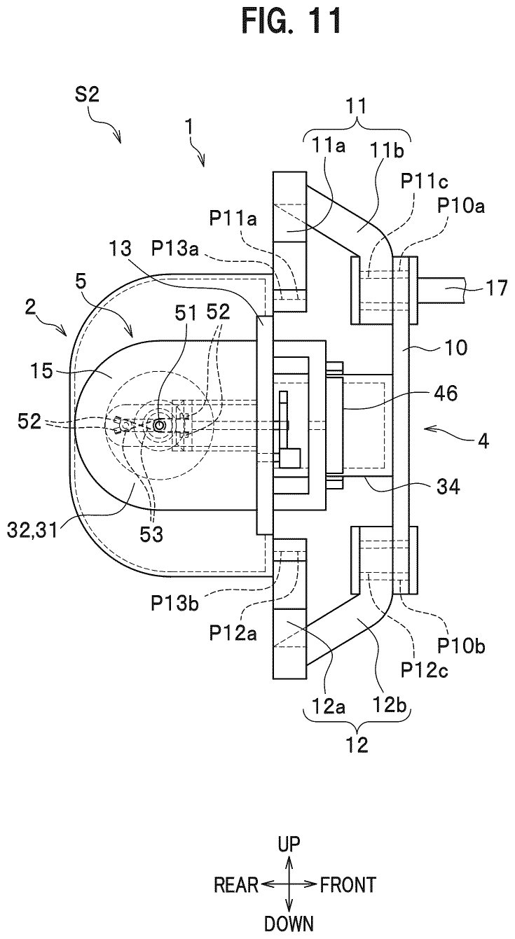

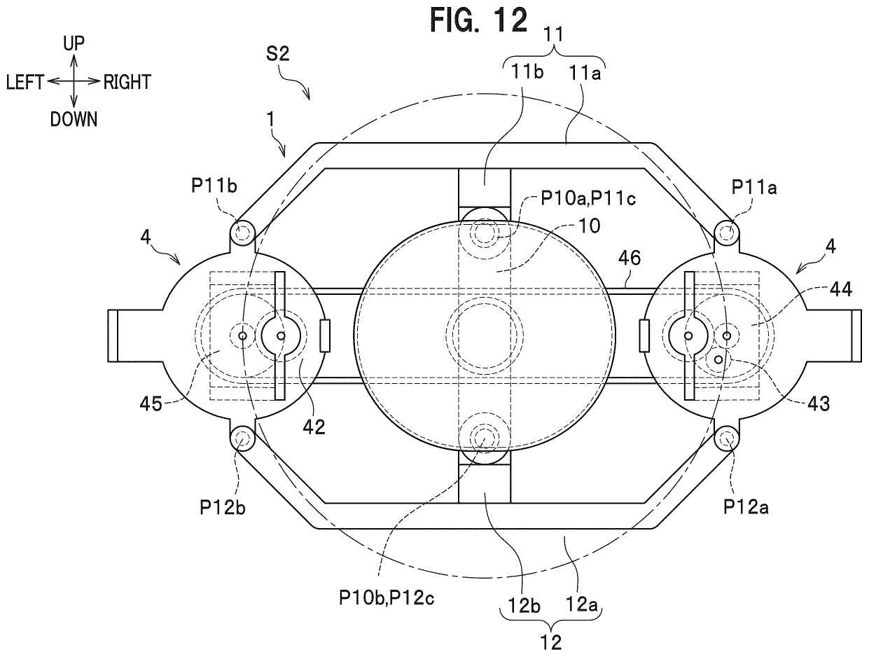

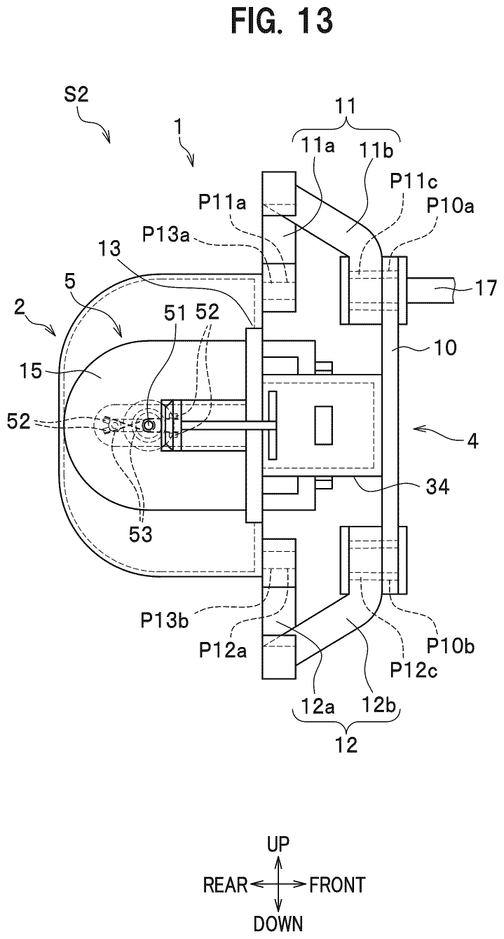

Next, a description is given in detail of a steering device S2 of a second embodiment, with reference to FIGS. 7 to 13. Note that components identical to those of the first embodiment are denoted by the same reference signs in the description, and duplicate descriptions thereof are skipped. The rotation axis of the control unit 31 is set to extend in the front-rear direction in the first embodiment, whereas that is set to extend in the lateral direction in the present embodiment. Accordingly, the steering device S2 of the present embodiment has a configuration of the right grip body 15, right control unit 32, left grip body 16, left control unit 33, and lateral interlocking means 4 different from that of the first embodiment, while other configurations remain the same.

The right grip body 15 is composed of a rod-shaped member similar to that of the first embodiment. The right grip body 15 extends in the lateral direction, with its right end supported by and fixed to the right grip base member 13. The right control unit 32 is positioned at a left end of the right grip body 15. The right operating gear 41 uses a bevel gear to convert an orientation of the rotation axis from lateral to front-rear.

The left grip body 16 is composed of a rod-shaped member similar to that of the first embodiment. The left grip body 16 extends in the lateral direction, with its left end supported by and fixed to the left grip base member 14. The left control unit 33 is positioned at a right end of the left grip body 16. The left operation gear 42 uses a bevel gear to convert an orientation of the rotation axis from lateral to front-rear. This configuration provides the same advantageous effects as those with the first embodiment.

### Third Embodiment

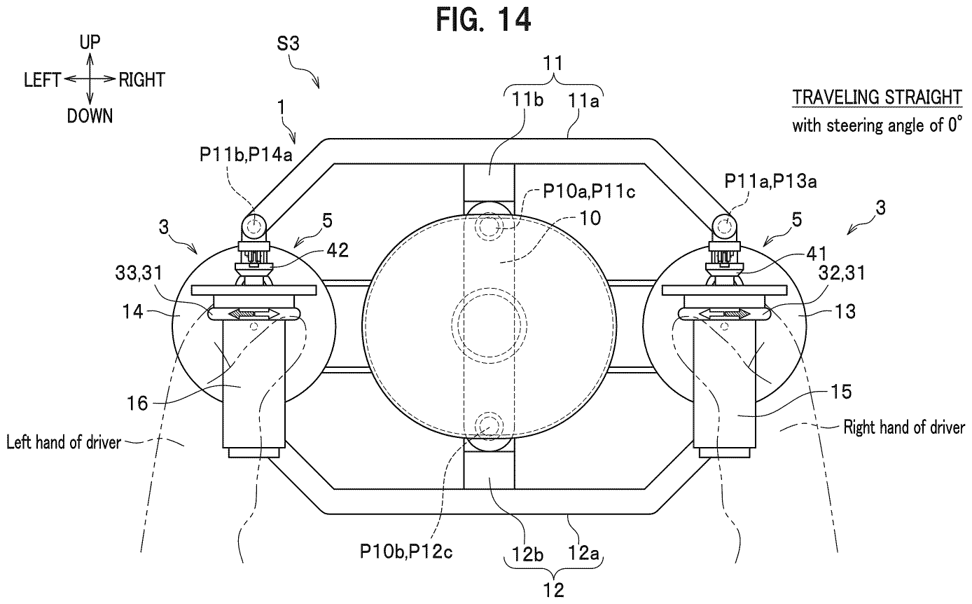

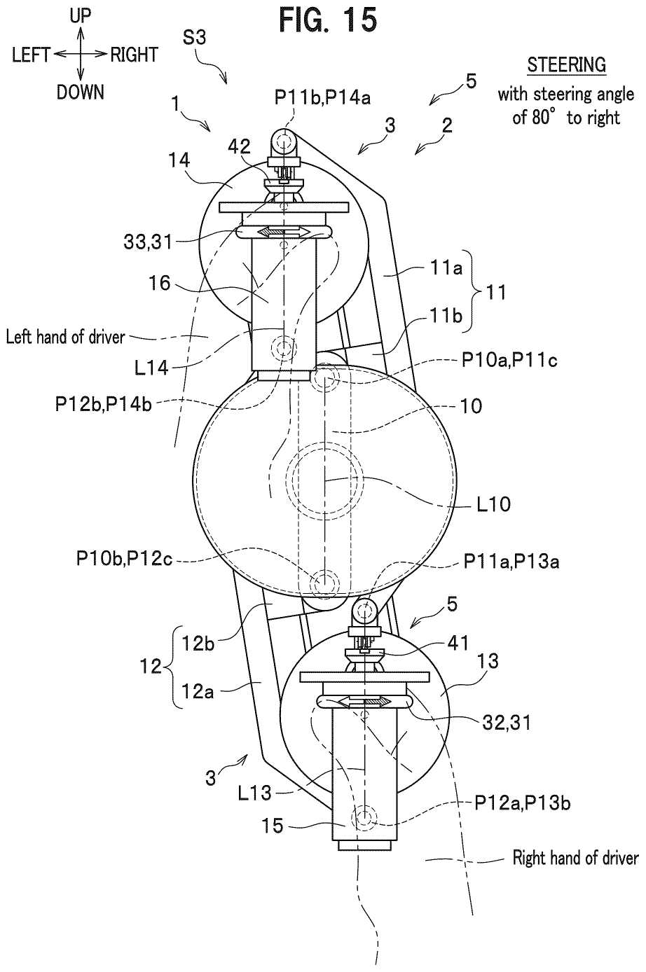

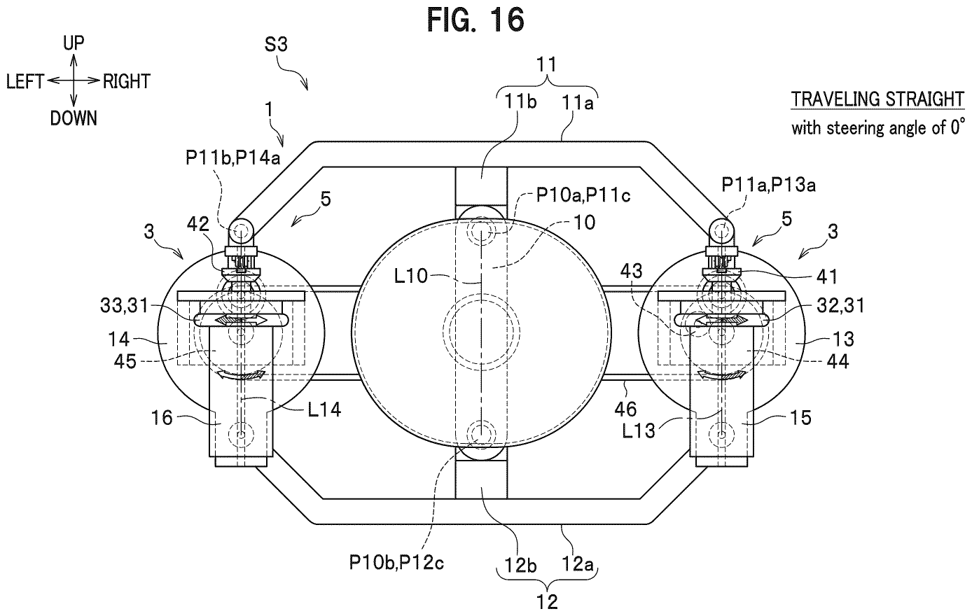

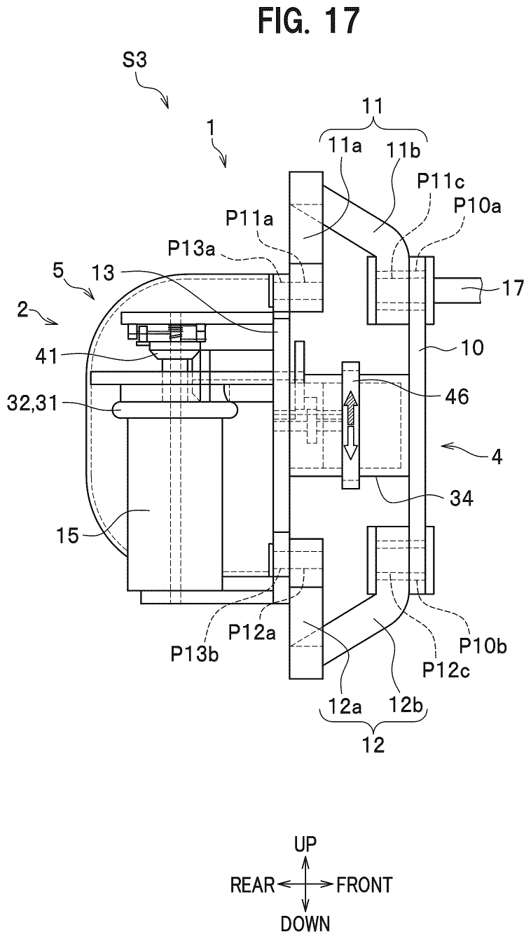

Next, a description is given in detail of a steering device S3 of a third embodiment, with reference to FIGS. 14 to 17. Note that components identical to those of the first embodiment are denoted by the same reference signs in the description, and duplicate descriptions thereof are skipped. The rotation axis of the control unit 31 is set to extend in the front-rear direction in the first embodiment, whereas that is set to extend in the vertical direction in the present embodiment. Accordingly, the steering device S3 of the present embodiment has a configuration of the right grip body 15, right control unit 32, left grip body 16, left control unit 33, and lateral interlocking means 4 different from that of the first embodiment, while other configurations remain the same.

The right grip body 15 is composed of a rod-shaped member similar to that of the first embodiment. The right grip body 15 extends in the vertical direction, with its lower end supported by and fixed to the right gripping base member 13. The right control unit 32 is positioned at an upper end of the right grip body 15. The right operation gear 41 uses a bevel gear to convert an orientation of the rotation axis from lateral to front-rear.

The left grip body 16 is composed of a rod-shaped member similar to that of the first embodiment. The left grip body 16 extends in the vertical direction, with its lower end supported by and fixed to the left grip base member 14. The left control unit 33 is positioned at an upper end of the left grip body 16. The left operation gear 42 uses a bevel gear to convert an orientation of the rotation axis from lateral to front-rear. This configuration provides the same advantageous effects as those with the first embodiment.

### Fourth Embodiment

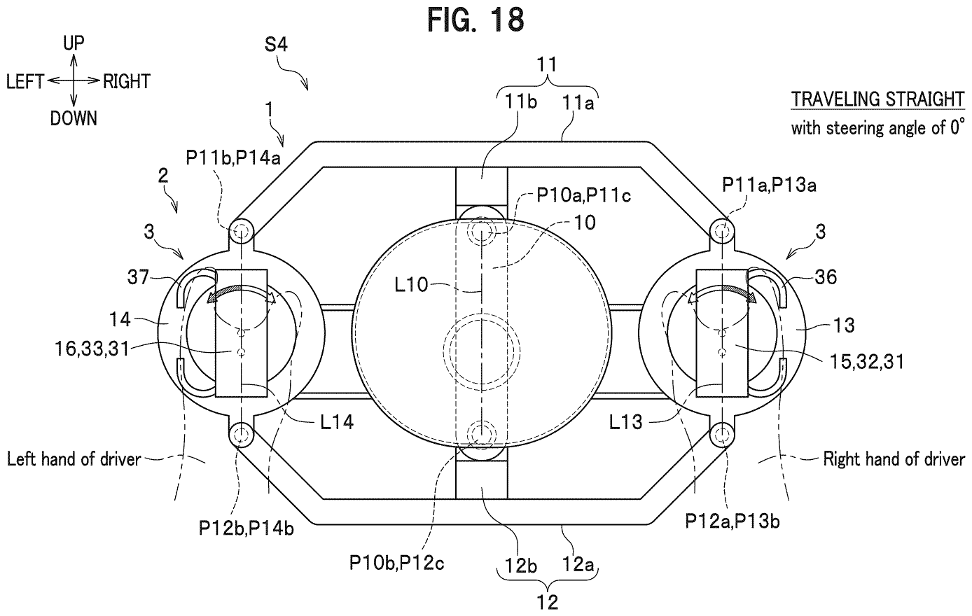

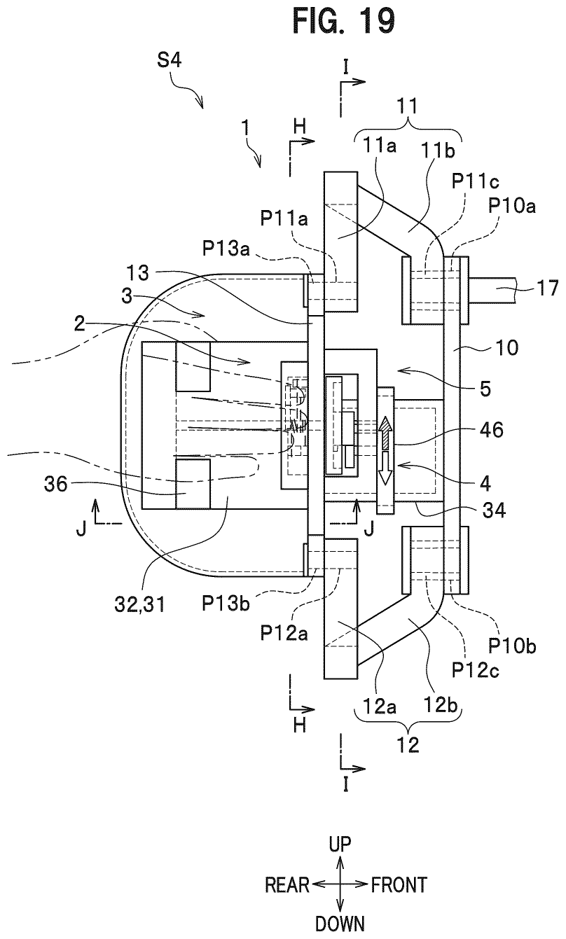

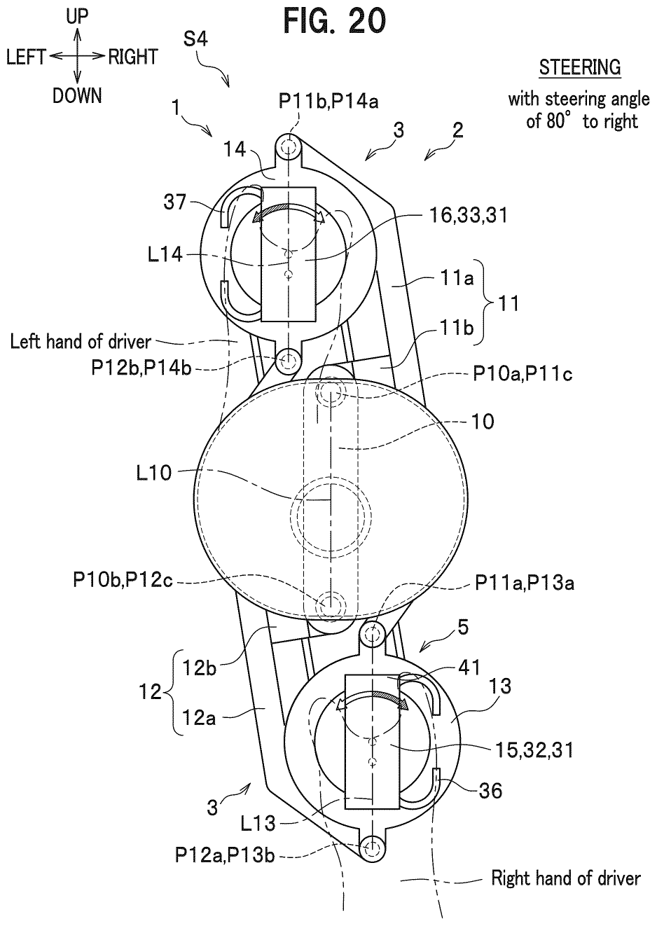

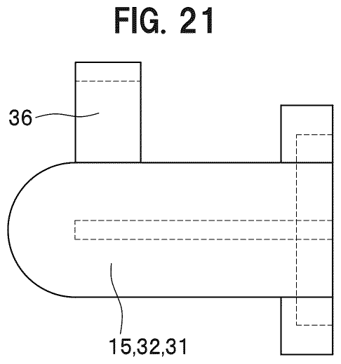

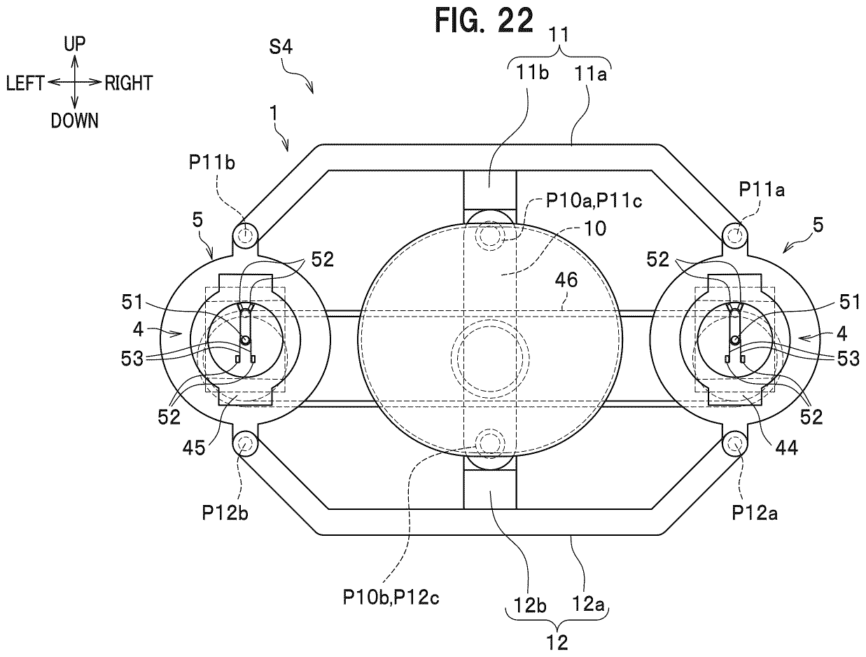

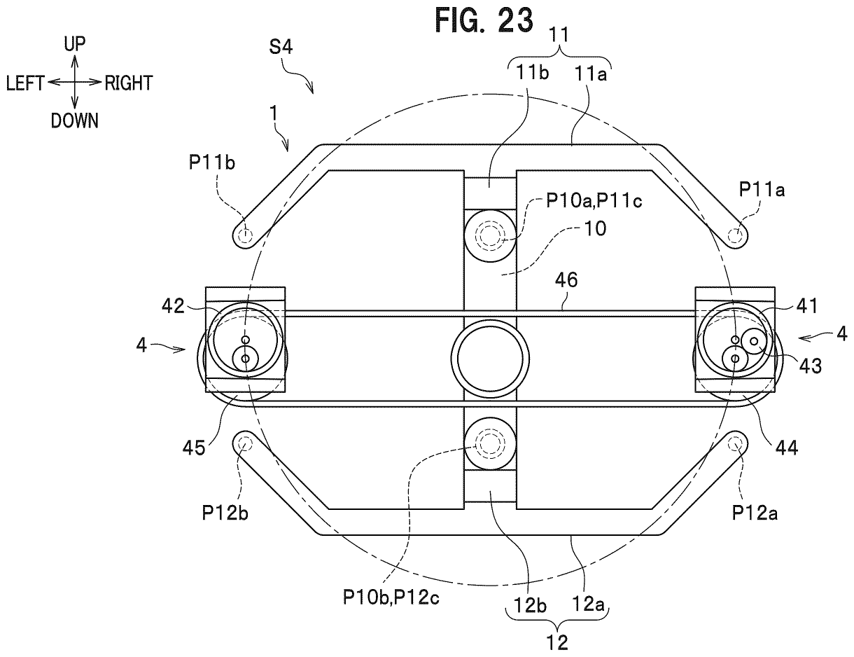

Next, a description is given in detail of a steering device S4 of a fourth embodiment, with reference to FIGS. 18 to 23. Note that components identical to those of the first embodiment are denoted by the same reference signs in the description, and duplicate descriptions thereof are skipped. The control unit 31 is configured as a separate member from the grip body in the first embodiment, whereas the right control unit 32 and right grip body 15 are integrated into a single component as well as the left control unit 33 and left grip body 16 are integrated into a single component in the present embodiment. In other words, the right and left grip bodies 15 and 16 are twisted for acceleration control (accelerator operation) and deceleration control (braking operation). Note that steering and turning are the same as those with the first embodiment.

A right grip support member 36 (grip support member) supports the back of the driver right hand while the palm faces left, and holds the inserted right hand. A left grip support member 37 (grip support member) supports the back of the driver left hand while the palm faces right, and holds the inserted left hand. The driver turns the palm upward or downward, or twists the wrist for acceleration and deceleration control. Such a configuration allows easy acceleration and deceleration control even for drivers, who have difficulty in acceleration and deceleration control with their fingers. This allows for driving safer, more securely, and more comfortably than before.

### LIST OF REFERENCE SIGNS

S1; S2; S3; S4: steering device, 1: steering wheel (link mechanism), 3: control means, 4: lateral interlocking means, 5: reaction force generating means, 10: mounting base member, 11: upper steering member, 12: lower steering member, 13: right grip base member (grip base member), 14: left grip base member (grip base member), 15: right grip body, 16: left grip body, 36: right grip support member (grip support member), 37: left grip support member (grip support member), P10a: upper mounting link point, P10b: lower mounting link point, P13a: upper right base link point (upper base link point), P13b: lower right base link point (lower base link point), P14a: upper left base link point (upper base link point), P14b: lower left base link point (lower base link point), L10: mounting line, L13: right base line (base line), and L14: left base line (base line).

1. A steering device comprising:
a mounting base member installed on a vehicle body;
a pair of grip base members arranged laterally on opposite sides of the mounting base member at equal distances;
an upper steering member connecting an upper mounting link point of the mounting base member and an upper base link point of the grip base member, via a rotation shaft along a front-rear or vertical direction;
a lower steering member connecting a lower mounting link point of the mounting base member and a lower base link point of the grip base member, via a rotation shaft along the front-rear or vertical direction;
a link mechanism linking the mounting base member and the grip base members so as to rotate a steering output shaft during steering with a mounting line, composed of a straight line connecting the upper and lower mounting link points, and a base line, composed of a straight line connecting the upper and lower base link points, remaining parallel to each other; and
a control means arranged on each of the grip base members and configured to accelerate and decelerate a vehicle.

2. The steering device according to claim 1, further comprising:
a lateral interlocking means configured to transmit operation on one of the control means to the other to interlock them.

3. The steering device according to claim 1, further comprising:
a reaction force generating means configured to bias the control means toward a direction opposite to the moving direction when a driver moves the control means.

4. The steering device according to claim 1, wherein
a control unit of the control means has a rotatably-supported dial shape.

5. The steering device according to claim 1, further comprising:
a grip body fixed to the grip base member,
wherein the control means is positioned so as to be controlled by a driver with fingertips of a gripping hand, while the driver gripping the grip body.

6. The steering device according to claim 4, wherein
the control unit of the control means includes a grip support member to support a driver hand.
